(19) United States
(12) Patent Application Publication
(10) Pub. No.: US 2025/0140885 A1
(43) Pub. Date: May 1, 2025

(54) SYSTEMS AND METHODS FOR EFFICIENT ELECTRICAL GENERATION FROM LIQUID FUELS

(71) Applicant: Northwestern University, Evanston, IL (US)

(72) Inventor: Scott A. Barnett, Evanston, IL (US)

(21) Appl. No.: 18/835,846

(22) PCT Filed: Feb. 9, 2023
(86) PCT No.: PCT/US23/62253

§ 371 Date: Aug. 5, 2024

Related U.S. Application Data
(60) Provisional application No. 63/267,793, filed on Feb. 10, 2022.

(51) Int. Cl. H01M 8/0612; H01M 8/04701; H01M 8/04746; H01M 8/12

(52) U.S. Cl. CPC H01M 8/0618; H01M 8/04708; H01M 8/04753; H01M 8/0631; H01M 8/12; H01M 2008/1293

(57) ABSTRACT

The present disclosure provides methods for generating electricity. In embodiments, a method for generating electricity comprises injecting a liquid fuel composition comprising a hydrocarbon and water into a reformer, the reformer under a pressure and at an elevated temperature to convert the liquid fuel composition to a reformate composition via a reforming reaction, the reformate composition comprising hydrogen and methane; and introducing the reformate composition into an anode inlet port of a solid oxide fuel cell in fluid communication with the reformer while introducing oxygen into a cathode inlet port of the solid oxide fuel cell under conditions to convert the reformate composition into an exhaust composition while generating electricity. Systems for carrying out the methods are also provided.

### CROSS-REFERENCE TO RELATED APPLICATIONS

The present application claims priority to U.S. provisional patent application No. 63/267,793 that was filed Feb. 10, 2022, the entire contents of which are incorporated herein by reference.

### REFERENCE TO GOVERNMENT RIGHTS

This invention was made with government support under DMR-1912530 awarded by the National Science Foundation. The government has certain rights in the invention.

### BACKGROUND

Many scenarios for reducing carbon emissions to zero by 2050 envision the use of renewable bio-fuels along with fossil fuels with CO₂ sequestration. Fossil fuels are needed because it will be difficult to completely meet energy needs using renewable resources only. By utilizing sequestration, CO₂ emissions from fossil fuels can be minimized, whereas combining renewable bio-fuels with sequestration can achieve net-negative emissions. The strategy typically invoked for sequestering fossil and renewable fuels is to convert them to hydrogen using centralized reforming plants; these point sources can be connected to a pipeline infrastructure to bring the CO₂ to sequestration sites, whereas the hydrogen is distributed for use in transportation and other applications. Note that this approach generally involves the use of pure hydrogen, in part because it is required for the low-temperature fuel cells (e.g., proton-exchange-membrane fuel cells (PEMFCs)) expected to be used in many heavy-duty vehicles.

A key question is how to most efficiently convert available fossil- or bio-fuels to hydrogen. In general, steam or autothermal reforming can be used, but in a case where it is desired to obtain a highly CO₂-rich exhaust for sequestration, the latter method is problematic since it utilizes air, resulting in substantial nitrogen dilution of the exhaust. The steam reforming method is well established and viable, having been applied to methane and also liquid fuels such as ethanol, gasoline, and diesel; however, the endothermic reaction requires that considerable heat be supplied, reducing efficiency. There are also gas separation and purification issues to be resolved for CO₂-neutral production of pure hydrogen, given that the reformation product is hydrogen containing substantial amounts of H₂O, CO, and CO₂. The CO₂ must be separated for sequestration, whereas the hydrogen must be purified, processes that have some efficiency penalty. The H₂ purification process is made more difficult by the need to reduce CO to ppm levels to avoid poisoning PEMFC catalysts, and normally requires at least two process steps including a water-gas shift reactor. Alternatively, membranes have been proposed for separating out pure H₂. Finally, the additional heat for reforming is typically provided by combusting additional fuel (e.g., methane) with air, resulting in a separate exhaust stream containing CO₂ heavily diluted with nitrogen, unless an oxygen membrane is used for oxy-combustion. Once the purified hydrogen is obtained, it is compressed or liquefied for transport and storage; both these processes are energy intensive. Leakage and boil-off can also introduce considerable efficiency penalties. The combination of the above losses can lead to a low overall efficiency, requiring the use of more of the valuable renewable fuel, and for the case of fossil fuels resulting in more CO₂ that will need to be sequestered.

### SUMMARY

The present disclosure provides methods for generating electricity. In embodiments, a method for generating electricity comprises injecting a liquid fuel composition comprising a hydrocarbon and water into a reformer, the reformer under a pressure and at an elevated temperature to convert the liquid fuel composition to a reformate composition via a reforming reaction, the reformate composition comprising hydrogen and methane; and introducing the reformate composition into an anode inlet port of a solid oxide fuel cell in fluid communication with the reformer while introducing oxygen into a cathode inlet port of the solid oxide fuel cell under conditions to convert the reformate composition into an exhaust composition while generating electricity.

Systems for carrying out the methods are also provided. In embodiments, a system for generating electricity comprises a reformer comprising a liquid injector through which a liquid fuel composition comprising a hydrocarbon and water is injected, and an outlet through which a reformate composition comprising hydrogen and methane is released, the reformer under a pressure and at an elevated temperature to convert the liquid fuel composition to the reformate composition via a reforming reaction; and a solid oxide fuel cell operatively connected to the reformer and comprising an anode inlet port through which the reformate composition is received, and a cathode inlet port through which oxygen is received, the solid oxide fuel condition under conditions sufficient to convert the reformate composition into an exhaust composition while generating electricity.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings, wherein like numerals denote like elements.

FIG. 1A shows the equilibrium gas composition after reformation of a liquid feed having a H₂O/EtOH molar ratio of 3 at 650° C. versus total pressure, and FIG. 1B shows the enthalpy change of the reforming reaction, assuming equilibrium products at 650° C., versus total pressure.

FIG. 2A shows the equilibrium gas composition after reformation of a liquid feed having a H₂O/EtOH molar ratio of 3 at 750° C. versus total pressure, and FIG. 2B shows the enthalpy change of the reforming reaction, assuming equilibrium products at 750° C., versus total pressure.

FIG. 3A shows the equilibrium gas composition after reformation of a liquid feed having a H₂O/EtOH molar ratio of 5 at 650° C. versus total pressure, and FIG. 3B shows the enthalpy change of the reforming reaction, assuming equilibrium products at 650° C., versus total pressure.

FIG. 4A shows the equilibrium gas composition after reformation of a liquid feed of H₂O/C₁₂H₂₄ having a H₂O per C ratio of 3 at 650° C. versus total pressure, and FIG. 4B shows the enthalpy change of the reforming reaction, assuming equilibrium products at 650° C., versus total pressure.

FIG. 5A shows the equilibrium gas composition after reformation of a liquid feed of H₂O/C₁₂H₂₄ having a H₂O per C ratio of 3 at 750° C. versus total pressure, and FIG. 5B shows the enthalpy change of the reforming reaction, assuming equilibrium products at 650° C., versus total pressure.

FIG. 6 shows a schematic of a system for generating electricity according to an illustrative embodiment.

FIG. 7 is a block diagram of illustrative additional components of the system of FIG. 6.

### DETAILED DESCRIPTION

Methods for generating electricity are provided. The methods comprise injecting a liquid fuel composition comprising a hydrocarbon and water (H₂O) into a reformer under pressure and at an elevated temperature to convert the liquid fuel composition to a reformate composition comprising hydrogen (H₂) and methane (CH₄). The methods further comprise introducing (e.g., directly) the reformate composition into an anode inlet port of a solid oxide fuel cell (SOFC) while introducing O₂ into a cathode inlet port of the SOFC under conditions to convert the reformate composition into an exhaust composition and generate electricity. The O₂ may be provided by air or an air/O₂ mixture or pure O₂. The pressure being used in the reformer is selected such that an enthalpy (ΔH) of the reforming reaction (i.e., the conversion of the liquid fuel composition to the reformate composition) is reduced as compared to the ΔH of the reforming reaction at ambient pressure (about 1 bar) (and otherwise the same conditions). The result is a substantial increase the in the conversion efficiency (i.e., efficiency of the conversion of the liquid fuel to the reformate composition) as compared to ambient pressure (and otherwise the same conditions). Although less H₂ (and more CH₄) is produced under the pressurized conditions in the reformer (as compared to ambient pressure), the CH₄ in the reformate composition is subsequently converted to H₂ in the SOFC (i.e., is “internally reformed”), making use of excess heat produced by SOFC operation. A synergy is achieved by this coupled, joint operation of the reformer and SOFC that results in a surprisingly high thermodynamic efficiency of steam reforming (nearly 90%). The present approach also differs from existing approaches in which the goal is to maximize the amount of H₂ produced by the reformer. The present approach also differs from existing reforming approaches used for hydrogen production (e.g., for PEMFCs) wherein any CH₄ produced is an unwanted byproduct that must be eliminated. At least one unique feature of the present approach is the ability to optimize the synergy between reformer and fuel cell to maximize efficiency. As further described in the Example, below, generating electricity using the present methods is also substantially more efficient than generating electricity in a PEMFC using hydrogen generated from a conventional steam reformer.

The liquid fuel composition comprises a hydrocarbon (or a blend of hydrocarbons) and water. By “liquid” it is meant that the composition is in its liquid phase prior to injection into the reformer and the composition is in its liquid phase as it is being injected into the reformer. By “hydrocarbon” it is meant a single type of hydrocarbon or a blend of different types of hydrocarbons. The hydrocarbon may be unsubstituted, e.g., C₈H₁₈, or substituted, as in alcohols such as ethanol. An illustrative liquid fuel composition comprises ethanol, although other alcohols may be used. A blend of hydrocarbons may be used, e.g., gasoline (e.g., gasoline comprising C₈H₁₈) or diesel (e.g., diesel comprising C₁₂H₂₄) may be used. The hydrocarbon is generally not methane, although this does not preclude liquid fuel compositions comprising methane as a minor component. In embodiments, the liquid fuel composition does not comprise methane. The liquid fuel composition may be injected into the reformer using a single liquid injector or multiple liquid injectors, e.g., one liquid injector for the water and another liquid injector for the hydrocarbon(s).

As noted above, the reformer is under pressure, i.e., a pressure greater than ambient pressure, and at an elevated temperature, i.e., a temperature greater than room temperature (about 25° C.). Otherwise, the pressure and temperature may be selected to achieve a target ΔH of the reforming reaction, while also minimize coking in the reformer. By “target,” it is meant a specific value as determined prior to carrying out the present methods. Selection of the reformer conditions to achieve this result is believed to be a unique feature of the present methods. This allows for “internal” reforming of the reformate composition within the SOFC, making use of excess heat produced by SOFC operation. This, in turn, maximizes efficiency by taking advantage of this excess SOFC heat. The pressurization of the reformer may be achieved by injecting the liquid fuel composition directly into a heated reformer. This may be accomplished by using a liquid pump configured to meter the liquid fuel composition into the reformer at the elevated temperature and a pressure gauge with feedback control of the flow rate of the liquid fuel composition to achieve and maintain the desired pressure.

In embodiments, the target ΔH of the reforming reaction is a value that is no more than 10% of a heat of combustion of the hydrocarbon (or the hydrocarbon blend) in the liquid fuel composition. This includes no more than 8% or no more than 5%. By “heat of combustion,” it is meant the amount of energy released as heat when the hydrocarbon undergoes complete combustion with oxygen under standard conditions. In determining the heat of combustion, the “hydrocarbon” refers to a single type of hydrocarbon if being used, or a blend of hydrocarbons (e.g., gasoline) if such a blend is used.

In embodiments, the selected pressure of the reformer is in a range of from 10 bar to 60 bar. This includes: from 15 bar to 60 bar, from 20 bar to 60 bar, from 25 bar to 60 bar, from 30 bar to 60 bar, from 35 bar to 60 bar, from 40 bar to 60 bar, from 45 bar to 60 bar, and from 50 bar to 60 bar. In embodiments, the selected temperature of the reformer is in a range of from 600° C. to 900° C. This includes: from 625° C. to 775° C., from 650° C. to 750° C., from 600° C. to 775° C., from 600° C. to 750° C., and from 600° C. to 700° C.

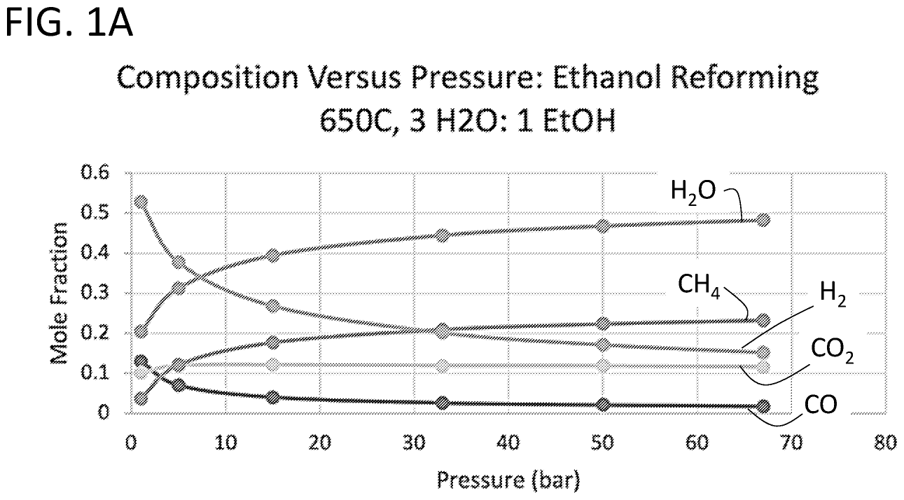

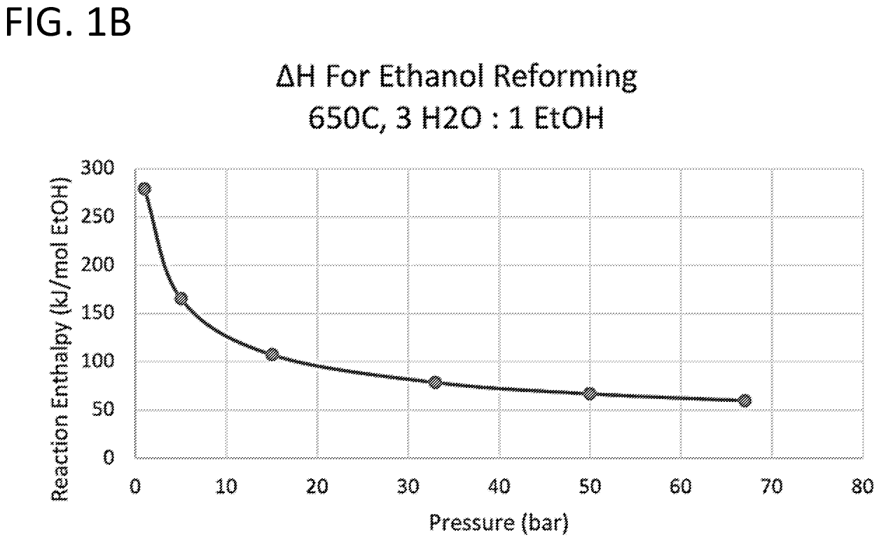

The reformate composition produced by the reforming reaction at the selected pressure and temperature comprises both H₂ and CH₄. The mole fraction of H₂ and the mole fraction of CH₄ in the reformate composition also depends upon the selected conditions being used in the reformer, as well as the specific liquid fuel composition being used. In embodiments, CH₄ is present in the reformate composition at a mole fraction of at least 0.10, at least 0.15, or at least 0.20. This includes embodiments in which the CH₄ mole fraction is in a range of from 0.10 to 0.20. In embodiments, H₂ is present in the reformate composition at a mole fraction of less than 0.50, less than 0.40, or less than 0.30. This includes embodiments in which the H₂ mole fraction is in a range of from at least 0.15 to less than 0.50, at least 0.20 to less than 0.50, or at least 0.15 to less than 0.40. Thus, as noted above, these CH₄ and H₂ amounts differ substantially from existing approaches in which the goal is to maximize the amount of H₂ produced by the reformer. Other components are generally present in the reformate composition, including H₂O, CO₂, and CO. (See FIGS. 1A, 2A, 3A, 4A, and 5A.) In embodiments, the reformate composition has ratio of H₂ (moles) to CH₄ (moles) that is in a range of from 9:1 to 0.5:1. This includes: from 7:1 to 0.5:1, from 5:1 to 0.5:1, from 3:1 to 1:1 and from 2:1 to 1:1.

The conversion efficiency of the reforming reaction may be quantified by comparing the ΔH of the reforming reaction to the heat of combustion of the hydrocarbon in the liquid fuel composition. As noted above, the present methods are characterized by reducing this ΔH as compared to that of ambient pressure reforming, therefore increasing the conversion efficiency as compared to ambient pressure reforming. Illustrative increases in conversion efficiency are described in the Example below.

The (water):(hydrocarbon) ratio, i.e., the steam-to-carbon ratio, in the liquid fuel composition may also be selected to ensure any of the ΔH of the reforming reaction values described herein (and thus, reformate compositions and conversion efficiencies) are achieved, as well as to minimize coking in the reformer. In this ratio, the “hydrocarbon” refers to a single type of hydrocarbon if being used, or a blend of hydrocarbons (e.g., gasoline) if such a blend is used. In embodiments, the steam-to-carbon ratio is at least 1.5:1. However, much larger values may be used to help avoid coking in the reformer. In embodiments, the steam-to-carbon ratio is in a range of from 1.5:1 to 3:1.

A variety of designs (i.e., selected from known configurations, components, materials) may be used for the reformer. In embodiments, a single liquid injector is used to inject both the water and the hydrocarbon of the liquid fuel composition. In embodiments, pressurization of the reformer is achieved by injecting the liquid fuel composition directly into a heated reformer. The reformer may comprise a catalyst for catalyzing the reforming reaction.

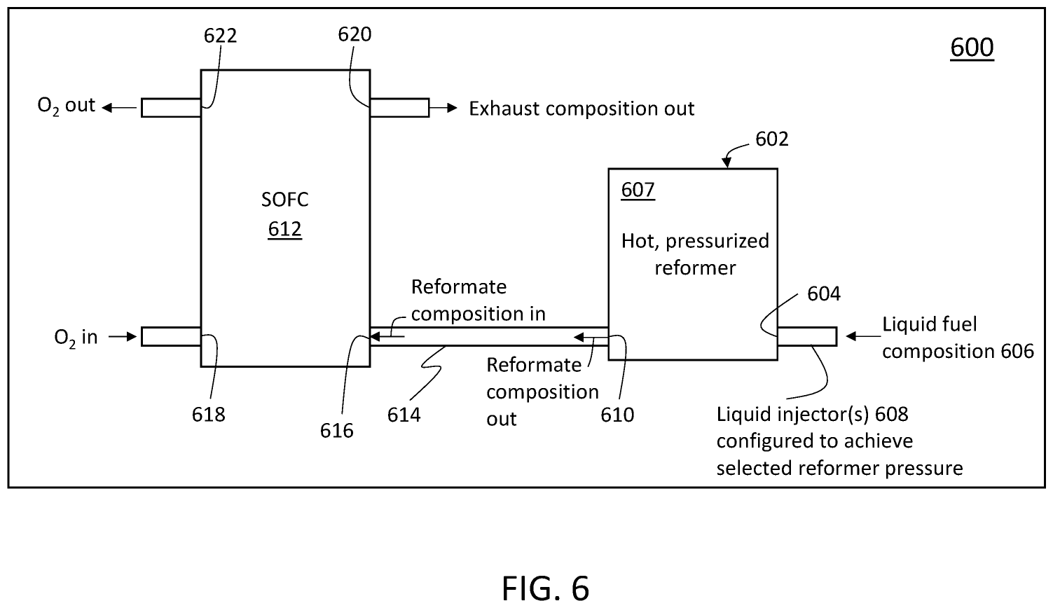

A schematic of a reformer 602 is shown in system 600 of FIG. 6, the reformer 602 comprises walls configured to contain hot, pressurized fluids. An inlet 604 allows for injection of a liquid fuel composition 606 into the interior 607 of the reformer 602 via one or more liquid injectors 608. Within the interior 607, the reforming reaction is carried out under the selected pressure and the selected temperature. An outlet 610 is in fluid communication with an SOFC 612 via a flow path 614, as further described below.

As noted above, the present methods further comprise introducing the reformate composition to a SOFC in order to generate electricity. (As used in the present disclosure, the term “SOFC” encompasses an individual SOFC as well as a stack of SOFCs.) A variety of SOFC designs may be used (i.e., selected from known configurations, components, materials), but each SOFC comprises an anode, a cathode, and a solid electrolyte separating the anode and the cathode.

A schematic of a SOFC 612 is shown in FIG. 6. An anode inlet port 616 is in fluid communication with the reformer 602 so as to receive the reformate composition via the flow path 614. As shown in FIG. 6, the reformer 602 and the SOFC 612 are directly connected. This means the reformate composition from the reformer 602 flows directly into the SOFC 612 without any additional processing (e.g., via a separator unit to remove chemical species from and/or separate gases in the reformate composition). Thus, the present methods may comprise delivering the reformate composition directly into a SOFC, i.e., without processing the reformate composition prior to delivery into the SOFC.

Referring back to FIG. 6, a cathode inlet port 618 is in fluid communication with a source of O₂ (e.g., air). An anode outlet port 620 allows for the release of an exhaust composition and a cathode outlet 622 allows for the release of unused O₂/air. The SOFC 612 is operated under conditions (e.g., 600 to 850° C.) so as to convert the reformate composition (effectively the fuel for the SOFC 612) into the exhaust composition. The exhaust composition comprises CO₂ and H₂O, but also generally comprises some H₂ and CO (see Table 1 in the Example, below). The SOFC 612 may be at ambient pressure or under a pressure greater than ambient pressure. If a pressurized SOFC 612 is used, however, in embodiments, the pressure of the SOFC 612 is not the same as the pressure of the reformer 602. Indeed, a unique feature of at least some embodiments of the present disclosure is that the pressure of the SOFC and the pressure of the coupled reformer are not be the same, i.e., are independently selected from one another. Although not shown in FIG. 6, a heat exchanger/condenser may be operatively coupled to the SOFC 612 and the reformer 602

The present methods may further comprise processing the exhaust composition produced by the SOFC, storing the exhaust composition, or combinations thereof, including as described in the Example below. By way of illustration and as further described in the Example below, pure oxygen may be stored during reverse operation (i.e., while the cell is running as a solid oxide electrolyzer cell) and then used to oxidize residual hydrogen in the SOFC exhaust.

Systems for carrying out the present methods are also encompassed. The systems comprise a reformer operatively connected to a SOFC. An illustrative such system 600 is shown in FIG. 6 and has been described above. Any of the reformers and SOFCs described herein may be used. The systems may be operatively connected to other devices or components of systems, e.g., a motorized vehicle, a home appliance, a fuel filling station, etc. The systems may be integrated with any of the energy storage systems described in International Patent Publication WO 2021/026122, which is hereby incorporated by reference in its entirety. Gauges for monitoring pressure, temperature, power, etc., may be included in the system 600 and operatively coupled to both the reformer 602 and the SOFC 612 so as to dynamically maintain both devices at those operating conditions that maximize efficiency at a given electrical power output. This ensures coupled, joint operation of the reformer 602 and the SOFC 612 and thus, the synergies described herein.

In addition, suitable systems for carrying out the present methods, including system 600, may include a controller configured to control one or more components of the system. The controller may be integrated into the system as part of a single device or its functionality may be distributed across one or more devices that are connected to other system components directly or through a network that may be wired or wireless. A database, a data repository for the system, may also be included and operably coupled to the controller.

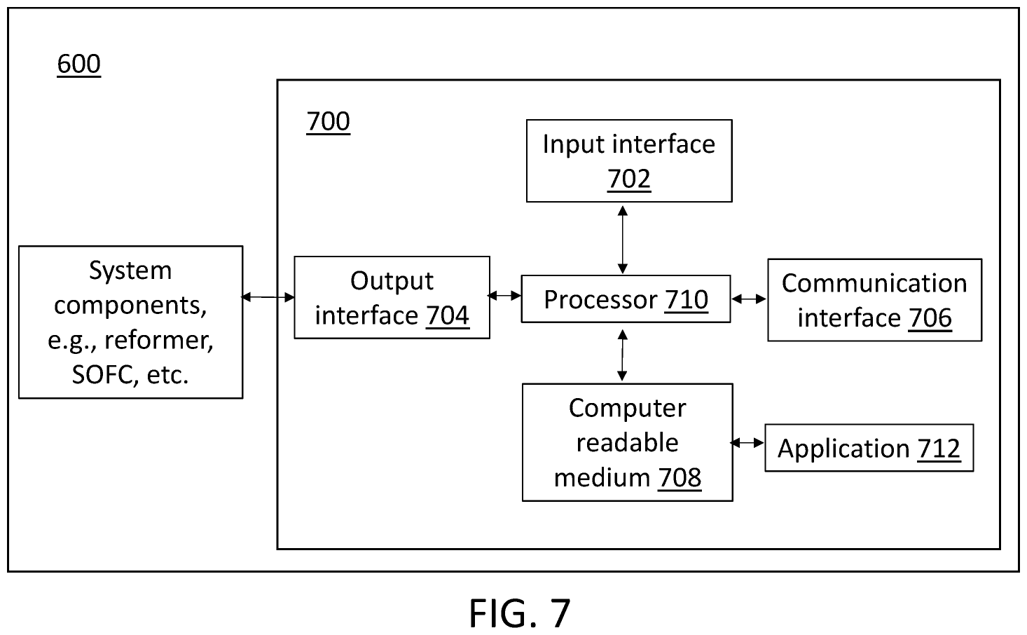

As shown in the illustrative embodiment of FIG. 7, a controller 700 which may be included in a suitable system for carrying out the present methods, including system 700, may include an input interface 702, an output interface 704, a communication interface 706, a computer-readable medium 708, a processor 710, and an application 712. The controller 700 may be a computer of any form factor including an electrical circuit board.

The input interface 702 provides an interface for receiving information into the controller 700. Input interface 702 may interface with various input technologies including, e.g., a keyboard, a display, a mouse, a keypad, etc. to allow a user to enter information into the controller 700 or to make selections presented in a user interface displayed on the display. Input interface 702 further may provide the electrical connections that provide connectivity between the controller 700 and other components of the system 600.

The output interface 704 provides an interface for outputting information from the controller 700. For example, output interface 704 may interface with various output technologies including, e.g., the display or a printer for outputting information for review by the user. Output interface 704 may further provide an interface for outputting information to other components 714 of the system 600.

The communication interface 706 provides an interface for receiving and transmitting data between devices using various protocols, transmission technologies, and media. Communication interface 706 may support communication using various transmission media that may be wired or wireless. Data and messages may be transferred between the controller 700, the database, other components of the system 600 and/or other external devices using communication interface 706.

The computer-readable medium 708 is an electronic holding place or storage for information so that the information can be accessed by the processor 710 of the controller 700. Computer-readable medium 708 can include any type of random access memory (RAM), any type of read only memory (ROM), any type of flash memory, etc. such as magnetic storage devices, optical disks, smart cards, flash memory devices, etc.

The processor 710 executes instructions. The instructions may be carried out by a special purpose computer, logic circuits, or hardware circuits. Thus, the processor 710 may be implemented in hardware, firmware, or any combination of these methods and/or in combination with software. The term “execution” is the process of running an application 712 or the carrying out of the operation called for by an instruction. The instructions may be written using one or more programming language, scripting language, assembly language, etc. Processor 710 executes an instruction, meaning that it performs/controls the operations called for by that instruction. Processor 710 operably couples with the input interface 702, with the output interface 704, with the computer-readable medium 708, and with the communication interface 706 to receive, to send, and to process information. Processor 710 may retrieve a set of instructions from a permanent memory device and copy the instructions in an executable form to a temporary memory device that is generally some form of RAM.

The application 712 performs operations associated with controlling other components of the system 600. Some of these operations may include receiving and/or processing data to be used while carrying out the present methods. Received data may include a pressure reading and a temperature reading of the reformer 602 of the system 600, e.g., from gauges(s) operatively connected to the system 600 (other gauges may be included as noted above). Received data may include the liquid fuel composition being used (i.e., the components of the liquid fuel composition and their amounts), e.g., as inputted by a user of the system 600. Processing data may include calculating the ΔH of the reforming reaction, the conversion efficiency, and/or the reformate composition, based on this received data. Other received data may include a target ΔH of the reforming reaction, a target conversion efficiency, and/or a target reformate composition (i.e., the components of the reformate compositions and their amounts), the value of each of which may be inputted by a user of the system 600. Processing data may include comparing any calculated values to respective target values. Other operations performed by the application 712 may include controlling components of the system 600 based on received and/or processed data, e.g., setting and/or adjusting the pressure and/or the temperature of the reformer 602 to achieve the target ΔH of the reforming reaction, the target conversion efficiency, and/or the target reformate composition. Thus, the present methods may further comprise adjusting the pressure and/or the temperature based on a comparison of a calculated ΔH of the reforming reaction, a calculated conversion efficiency, a calculated reformate composition, or combinations thereof, to respective values of a target ΔH of the reforming reaction, a target conversion efficiency, a target reformate composition, or combinations thereof.

Some or all of the operations described in the present disclosure may be controlled by instructions embodied in the application 712. The operations may be implemented using hardware, firmware, software, or any combination of these methods. With reference to the illustrative embodiment of FIG. 7, the application 712 is implemented in software (comprised of computer-readable and/or computer-executable instructions) stored in the computer-readable medium 708 and accessible by the processer for execution of the instructions that embody the operations of application 712. The application 712 may be written using one or more programming languages, assembly languages, scripting languages, etc.

It is noted that devices including the processor 710, the computer-readable medium 708 operably coupled to the processor 710, the computer-readable medium 708 having computer-readable instructions stored thereon that, when executed by the processor 710, cause the device to perform any of the operations described above (or various combinations thereof) are encompassed by the disclosure. The computer-readable medium 708 is similarly encompassed.

### Example

### Introduction

This Example describes an alternative means for electrical generation utilizing liquid fossil or bio-fuels with high efficiency. The main applications are for transportation or for achieving CO₂-negative electrical generation. The proposed approach utilizes a pressurized steam reformer to produce an impure hydrogen fuel that can be injected directly into a solid oxide fuel cell (SOFC). High efficiency is achieved for several reasons: 1.) The pressurized reformer reaction produces hydrogen containing substantial methane, such that the overall reaction is much less endothermic. 2.) The as-reformed fuel does not need to have the CO₂ separated or be otherwise processed to produce pure hydrogen, because the impure hydrogen is an ideal fuel for use in SOFCs. This is unlike a reformer/PEMFC power generation system where substantial energy is required to separate hydrogen, for use in the PEMFC, and CO₂, for sequestration or re-use. 3.) The residual methane is internally reformed in the SOFC, making good use of the excess heat produced during SOFC operation and thereby helping to cool the SOFC. Thus, the need for additional process heat is mostly eliminated, improving efficiency. Further, there is a small additional efficiency benefit by reducing stack air cooling blower energy. 4.) Since the pressurized reformer is a relatively simple compact device, the liquid fuel can be reformed at the point of use, avoiding the need for hydrogen compression and transport. 5.) SOFCs oxidize fuels with pure oxygen, yielding a product gas that is rich in CO₂ and thereby nearly ready for sequestration. Note that for transportation applications, this approach requires that the CO₂ product be captured on board the vehicle and then be transferred to the CO₂ network for sequestration during re-fueling. 6.) SOFCs provide very high electrical efficiency >60%. 7.) Little energy is required to inject liquids into a hot high-pressure reformer, compared to pressurizing a gas.

While the above points focus on efficiency advantages, it should also be noted that the present approach also minimizes the technical problems associated with separating CO₂ from the reformate stream and completely avoiding hydrogen purification and compression. The pressurized reformer also has the advantage of converting a wide range of fuels to the desired H₂ and CH₄ rich mixture that works with currently available SOFCs, which is important given the immediacy of climate change.

The following discussion takes a detailed look at the key features and advantages of using a pressurized external reformer in combination with an SOFC. Methods for utilizing residual fuel from the SOFC exhaust without substantial nitrogen dilution, in order to make it fully sequestration ready, are also discussed.

### Methods

In order to evaluate the results of pressurized reforming, it is important to know the product gas constitution. However, experimentally measured reforming results show variability depending upon the reforming conditions and the composition and effectiveness of the catalyst material. Rather than attempting to consider many different reformer types and conditions, the present example uses an equilibrium calculation to provide reasonable gas constitutions. It is a reasonable assumption that most reformer catalysts are sufficiently active that the reformate composition is reasonably close to the equilibrium. Although results with actual reformers will differ somewhat from the present equilibrium results, they provide a qualitative assessment of the effects of reformer pressurization.

The equilibrium thermodynamic calculation shows how the reformate gas composition changes with pressure, and in turn, how the enthalpy of the reforming reaction changes. The calculation was carried out by minimizing the total free energy of the following species: H₂, CH₄, CO, CO₂, C (graphite), and H₂O. Other species may be present at equilibrium, but their amounts are relatively small (<<1%) such that they do not significantly impact the results. Note that solid carbon is not present at equilibrium for the conditions studied here.

### Results

### Ethanol Reforming

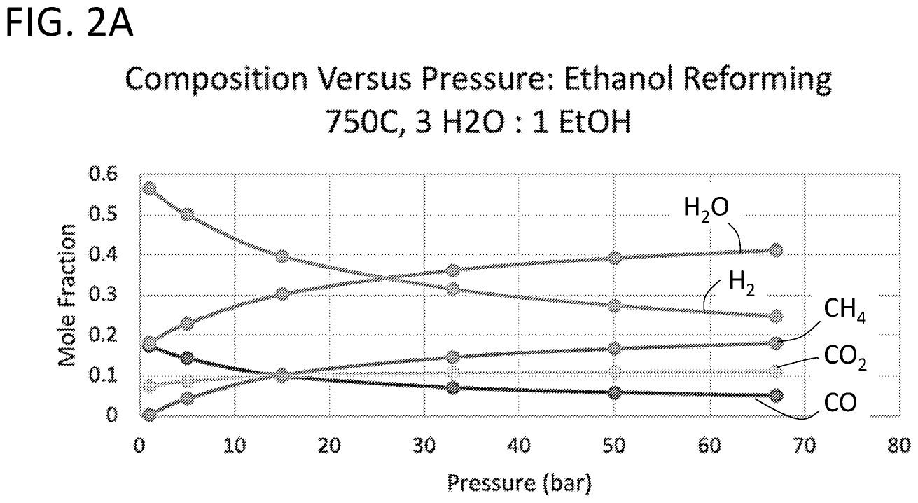

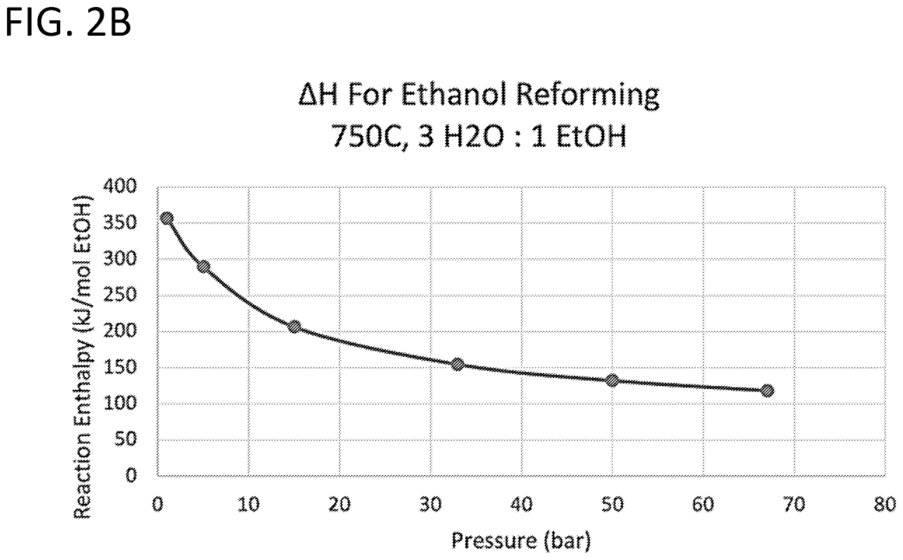

Note that a single liquid fuel injector can be used here for the ethanol/water mixture, providing a particularly simple reformer design. Steam to ethanol molar ratios of 3 and 5 are used here as examples. The ratio 3 is generally the lowest value at which coking in the reformer can be avoided. The calculations are performed for reformer temperatures of 650 and 750° C. FIGS. 1A-1B summarize the results at 650° C., and FIGS. 2A-2B summarize the results at 750° C.

In general, the H₂ and CO mole fractions decreased with increasing pressure P, whereas the CH₄ and H₂O, fractions increased. The CO₂ fraction varied weakly. The CH₄ and H₂O, fractions were higher, and the H₂ and CO mole fractions lower, at the lower temperature (T). The endothermic enthalpy change decreased with increasing P, and decreased to lower values at the lower T. The P and T dependences can be explained by the changes in methane content—the reaction enthalpy is generally less endothermic for the reaction to methane versus hydrogen. For example, the enthalpy decreased from 280 to 67 KJ/mol ethanol upon increasing the pressure from 1 to 50 bar, at 650° C. To put this into perspective, the heat requirement for ambient-pressure reforming decreased from 20.5% of the total heat of combustion of ethanol (−1366.8 KJ/mol), to only 5.0% at P=50 bar. That is, pressurization can improve the overall efficiency of conversion by >15%. Finally, note that pressurization reduced the CO content in the fuel, in some cases to just a few percent; this may be advantageous from a safety perspective in cases where the fuel is stored or transported.

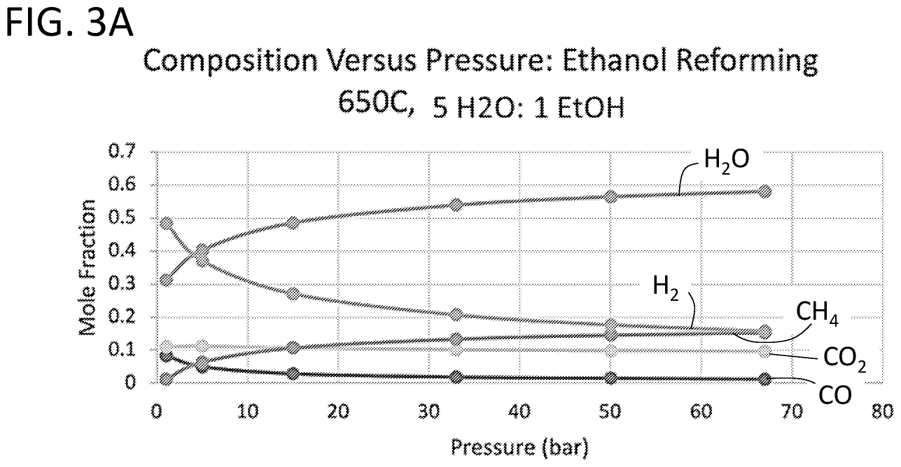

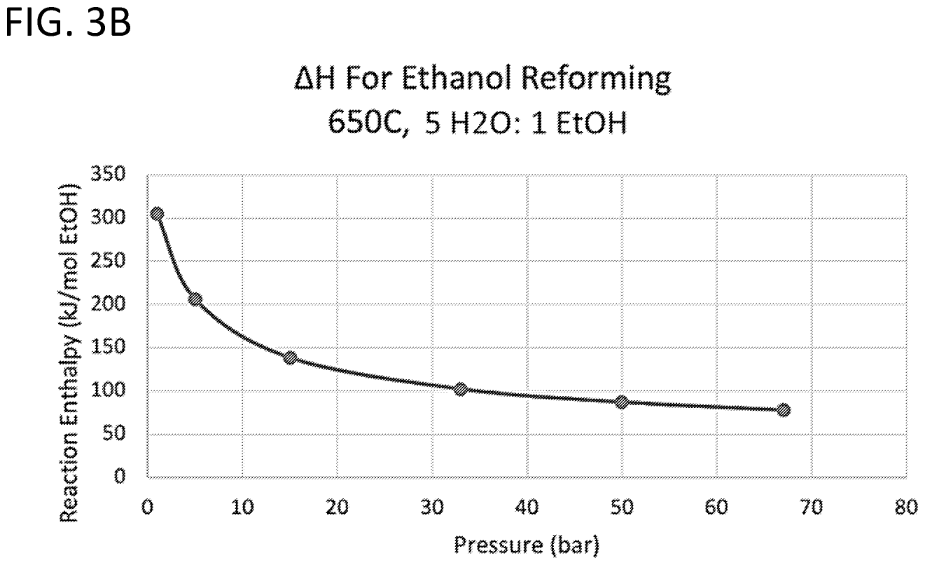

It may be desirable to utilize a fuel with a higher H₂O/EtOH ratio, both because the risk of coking in the reformer is reduced and because the bio-fuel would require less distillation. The equilibrium calculations for the case of a H₂O/EtOH molar ratio of 5, presented in FIGS. 3A-3B, are qualitatively similar to those shown in FIGS. 1A-1B and 2A-2B. The reduction in the reforming enthalpy was similar, but the H₂ and CH₄ fractions were lower with a higher H₂O fraction.

Using the 650° C. reformer with H₂O/EtOH=3 as the base case, the net heat energy available in the reformate was lower in the pressurized case (1251.5 KJ/mol EtOH at 50 bar versus 1446.5 at 1 bar), but this energy was recovered in the SOFC where the residual methane in the fuel was reformed using the excess heat energy produced by cell operation. The net heat of combustion available in the reformate was −1252 kJ (all values here are per mole of the original ethanol), and assuming the electrical efficiency of the SOFC was 60%, and the fuel utilization was 85%, then the excess heat produced within the SOFC stack was 25% or 314 kJ, more than the heat required to internally reform the CH₄ in the reformate, 261 kJ (note that for 1 bar reforming, the heat required to internally reform the small amount of residual CH₄ in the reformate was only 57 kJ). In addition to the reforming efficiency improvement of 15% due to pressurization noted above, small additional improvements in system efficiency are expected, e.g. reduced parasitic loss due to the reduced requirement to flow cooling air through the stack.

The pressurized reformate fuel compositions for ethanol shown in FIGS. 1A, 2A, and 3A are well suited for use in an SOFC. The CH₄ content of ˜20%, with H₂O fraction roughly double that, is suitable for SOFC operation without coking of the anode. The H₂ fraction was >15% at all pressures; thus, even at the fuel inlet, there is sufficient H₂ for SOFC operation.

### Heavy Hydrocarbon Reforming

Similar calculations were carried out for an average heavy hydrocarbon fuel composition representative of diesel: C₁₂H₂₄. Separate hydrocarbon and water liquid injectors were used in this case due to their mutual insolubility. A steam-to-carbon ratio of 3 was use to avoid coking. Higher H₂O content in the reformate is expected compared to the ethanol case above.

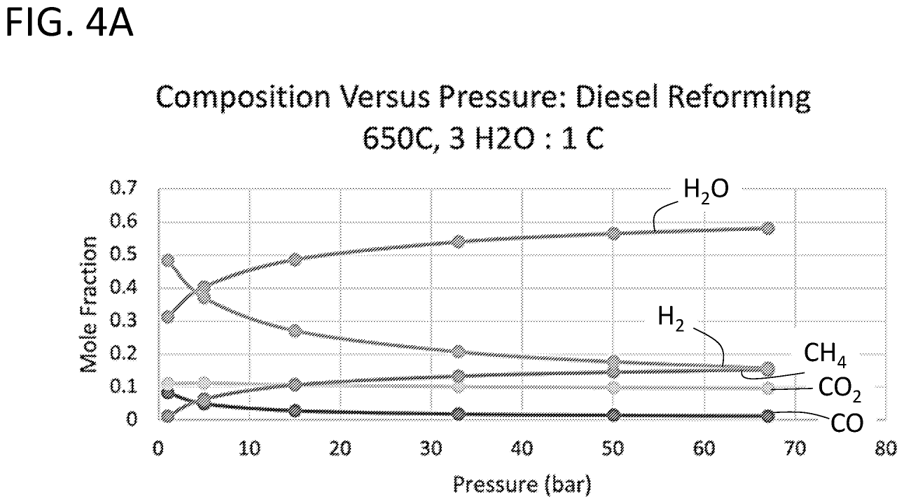

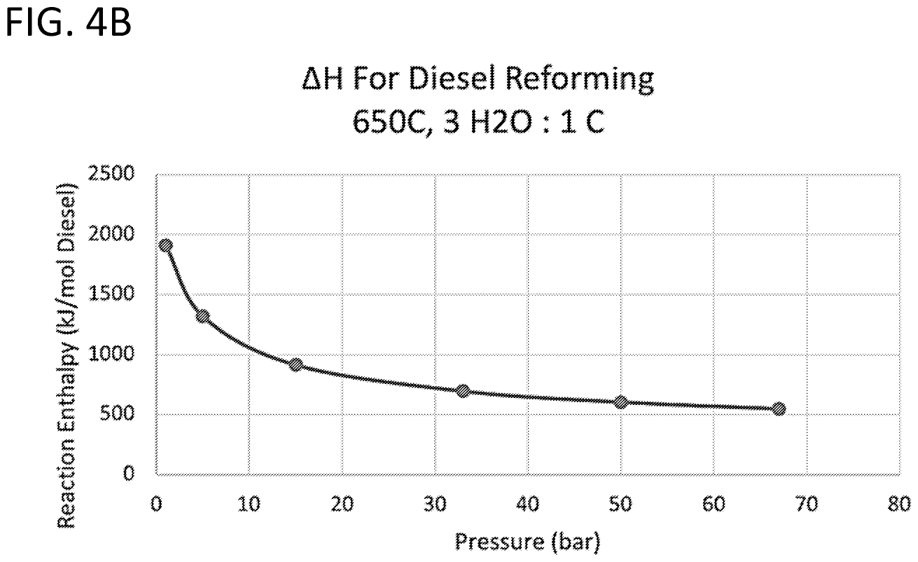

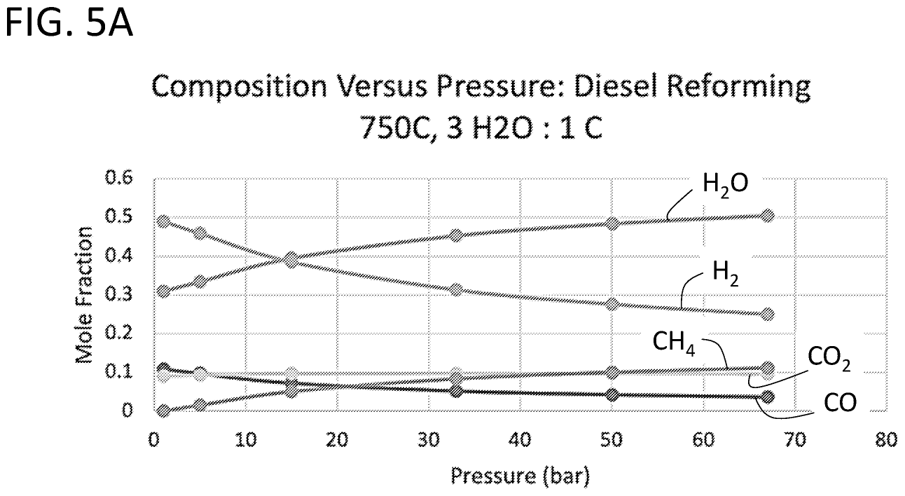

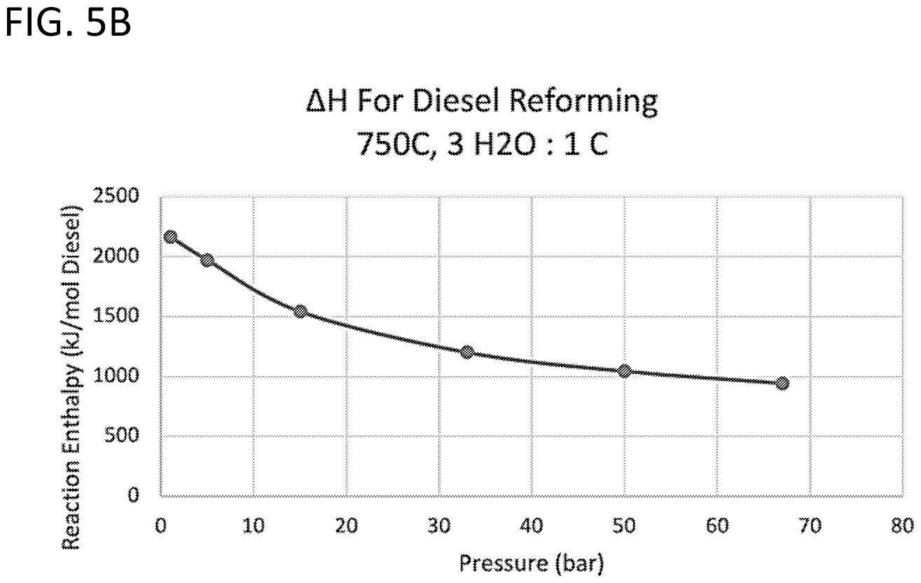

The calculations were performed for reformer temperatures of 650 and 750° C. FIGS. 4A-4B summarize the results at 650° C., and FIGS. 5A-5B summarize the results at 750° C.

In general, the trends here are similar to those noted above for ethanol reforming. That is, the H₂ and CO mole fractions decreased with increasing pressure P, whereas the CH₄ and H₂O, fractions increased. The CO₂ fraction varied weakly. The CH₄ and H₂O fractions were higher, and the H₂ and CO mole fractions lower, at the lower temperature (T). In general, the steam content was higher and the CH₄ content lower than for the ethanol case, primarily because of the higher H₂O-to-C ratio. The endothermic enthalpy change decreased with increasing P, and decreased to lower values at the lower T. For example, the enthalpy decreased from 1900 to 600 KJ/mol diesel upon increasing the pressure from 1 to 50 bar, at 650° C. To put this into perspective, the heat requirement for ambient-pressure reforming decreased from 28.4% of the total heat of combustion of diesel (−6700 KJ/mol), to only 9.0% at P=50 bar. That is, pressurization can improve the overall efficiency of conversion of diesel by nearly 20%. Finally, note that pressurization reduced the CO content in the fuel, in some cases to just a few percent; this may be advantageous from a safety perspective in cases where the fuel is stored or transported.

The pressurized reformate fuel compositions for ethanol shown in FIGS. 4A and 5A are also well suited for use in an SOFC. The CH₄ content of 10-20%, with H₂O fraction more than double that, is suitable for SOFC operation without coking of the anode. The H₂ fraction was >16% at all pressures; thus, even at the fuel inlet, there is sufficient H₂ for SOFC operation.

### Exhaust Gas Processing for Sequestration

The fuel utilization of SOFCs is typically only 80-90%, such that there is residual fuel retained in the exhaust that should be oxidized prior to sequestration. Residual fuel oxidation releases valuable heat that can be used for fuel cell system requirements such as boiling water, gas pre-heating, and for the fuel reformer. However, oxidation with air is problematic because it will dilute the CO₂ with substantial nitrogen, making sequestration more difficult. Possible means for oxidizing the residual fuel are examined below, including oxidation with membrane-enriched air, and the use of pure oxygen from a membrane or from a SOFC that is operated in electrolysis mode part of the time.

For this discussion, it was assumed that the SOFC operated with a typical 85% fuel utilization efficiency (defined to mean that the net current obtained for a given fuel flow rate is 85% of the maximum that could be obtained assuming complete utilization). Table 1 shows the expected exhaust gas compositions at equilibrium for ethanol fuel with the 3:1 H₂O/EtOH reformer composition. The exhaust composition was 9% H₂ and 2.5% CO, 66% H₂O and 22.5% CO₂. After cooling to condense the H₂O from the exhaust, the remaining exhaust gas contained ˜⅔ CO₂, ⅓ fuel (H₂ and CO). Results for diesel fuel, for reforming conditions as discussed above and the same 85% fuel utilization, were similar to those for ethanol. In the following, the values for the ethanol fuel case were used to illustrate the results.

If one were to remove the residual fuel by adding the stoichiometric amount of air and catalytically combusting, the resulting gas would be 48% N₂ (after H₂O removal). That is, the required sequestration volume would be doubled compared to that required for pure CO₂. This is still much better than if one were to simply combust the starting fuel with air (since most of the fuel is being oxidized by pure oxygen by the SOFC), where nitrogen would make up 85% of the exhaust assuming a stoichiometric amount of air is used; that is, the storage volume would be 6 times that needed for pure CO₂-prohibitively large.

It is desirable to cut the N₂ content below the 48% that would result from combusting the residual fuel in the SOFC exhaust with air. One possibility is to use enriched air, with a typical composition of 30% O₂ that is reached using existing relatively simple and inexpensive membrane processes. In this case, the N₂ content is reduced to a level where the storage volume would be only ˜50% larger than for pure CO₂. A more extensive membrane enrichment process, although more expensive and energy intensive, is possible. Enrichment to 50% O₂, for example, would yield 75% H₂O, 25% CO₂ diluted with 6.25% N₂ (71.5% H₂O, 23.5% CO₂, 6% N₂), resulting in ˜80% CO₂, 20% N₂ after condensing out the water. Thus, the volume of gas to be sequestered would be only 25% larger than for pure CO₂.

TABLE 1
Exhaust gas compositions for ethanol fuel combusted in air and
in SOFC assuming 85% fuel utilization, before and after water
removal, and after post-oxidation using different methods.

| | CO₂ | H₂O | H₂ | CO | N₂ |
|---|---|---|---|---|---|
| Gas | (%) | (%) | (%) | (%) | (%) |
| Air combustion exhaust | 12 | 17.5 | 0 | 0 | 70.5 |
| Air combustion | 15 | 0 | 0 | 0 | 85 |
| exhaust, H2O removed | | | | | |
| SOFC exhaust | 22.5 | 66 | 9 | 2.5 | 0 |
| SOFC exhaust, | 66 | 0 | 26.5 | 7.5 | 0 |
| H₂O removed | | | | | |
| SOFC exhaust, residual | 52 | 0 | 0 | 0 | 48 |
| oxidized with air, | | | | | |
| H₂O removed | | | | | |
| SOFC exhaust, residual | 65 | 0 | 0 | 0 | 35 |
| oxidized with 30% O₂, | | | | | |
| H₂O removed | | | | | |
| SOFC exhaust, residual | 81 | 0 | 0 | 0 | 19 |
| oxidized with 50% O₂, | | | | | |
| H₂O removed | | | | | |

It can also be proposed to use an existing high-temperature solid state membrane that produces pure oxygen, in order to provide oxygen to combust the residual fuel and yield an essentially pure CO₂ exhaust for sequestration.

While the membrane process is more complicated and expensive, using membrane oxygen to combust the residual fuel in SOFC exhaust may be more viable compared to oxidizing all the fuel directly, because only ˜⅙ of the oxygen would be required.

Another way to obtain pure oxygen, in the case of stationary power generation, is by using the SOFC itself. SOFCs can be operated in reverse part of the time, i.e., as solid oxide electrolysis cells (SOECs). This would utilize renewable electricity at times when there is excess electricity, providing energy storage by conversion to a renewable fuel. This is more desirable than operating the SOFC continuously, including times when there is no electricity demand, or shutting it down periodically. A useful by-product of the SOEC process is pure oxygen; if this is captured and stored during SOEC operation, it can subsequently be used to oxidize the residual fuel in the exhaust to produce sequestration-ready pure CO₂. It would require ˜½ mole O₂ from electrolysis per mole ethanol to oxidize the residual fuel with pure oxygen, an amount that would be produced if operating in SOEC mode at least 15% of the time (assuming equal current densities in fuel cell and electrolysis modes).

Another reason for combusting the residual fuel in the SOFC exhaust is that the resulting heat has value for improving SOFC efficiency. Based on the exhaust constitution numbers for the case of the 3:1 H₂O:EtOH fuel mixture (Table 1), for example, ˜157 kJ of heat is produced per mole of EtOH fuel. This available heat would most likely be used for pre-heating gases entering the stack and for boiling the water/ethanol fuel mixture. For boiling, the heat required is ˜164 kJ per mole of EtOH fuel. That is, the exhaust combustion heat is nearly sufficient to provide the heat required for boiling the fuel.

Finally, in the context of a small vehicle, it would also be reasonable to capture the impure CO₂ exhaust and then oxidize the residual fuel after offloading, to maintain a simple vehicle design. The drawback of this is that the heat of combustion is not available for use in the SOFC system. Another use of the unaltered SOFC product gas would be for use as a feedstock for producing renewable fuels by, e.g., steam/CO₂ electrolysis followed by a catalytic process; in this case, the SOFC product can probably be used directly, with the residual H₂ ending up in the final renewable fuel, thereby improving overall efficiency.

### DISCUSSION

Steam reforming may be used to produce hydrogen. A key advantage is that the hydrogen can be produced at centralized facilities; from there, hydrogen is distributed for various applications, and the by-product CO₂ can be routed to underground sequestration sites. However, the product gas is not pure hydrogen, but rather a H₂-H₂O—CO—CO₂—CH₄ mixture. For use in PEMFCs, reasonably pure hydrogen is required (the CO in particular must be reduced to ppm levels). Additionally, the CO₂ product must be separated for sequestration. Thus, additional processing steps are needed-typically including a water-gas shift reactor and CO removal. Alternatively, hydrogen membranes have been proposed to produce a pure hydrogen product; note that these provide limited flow rates and require expensive Pd-based membranes. These measures introduce additional system cost and complexity.

Here, centralized steam reforming to produce pure hydrogen for use in PEMFCs, as outlined above, was compared with the present approach of pressurized steam reforming to produce impure hydrogen for use in SOFCs. Overall energy efficiency is a key difference. The following points outline the main efficiency differences: 1.) As detailed in the above results for the enthalpy of the pressurized reforming reaction, the heat energy required was reduced to ˜30% of that required for atmospheric pressure reforming. Using ethanol as the example, the heat required for reforming was reduced from ˜300 to ˜100 kJ per mole of ethanol. Since the heat of combustion of ethanol is 1360 KJ/mol, the reforming efficiency was improved from 78% to 92.5%. 2.) The energy for compression of hydrogen to the typical ≥700 bar storage pressure is energy intensive, requiring ˜10% of the energy in the hydrogen. By contrast, the energy cost for compression when injecting the liquid into the high temperature reactor is negligibly small. 3.) In cases where the hydrogen is used in fuel cells, SOFCs used with impure hydrogen generally provide ˜60% electrical efficiency, compared to ˜50% for PEMFCs used with pure hydrogen.

Other factors, such as the separation and purification of H₂ and CO₂ will also introduce an efficiency penalty, but the amount is difficult to estimate. Overall, the present process increases the fuel-to-electricity efficiency from 35% to ˜55.5%. To put this into context, it would require nearly 60% greater land area to produce the bio-fuel for the pure-H₂ PEMFC case compared to the impure-H₂ SOFC case. For the case of fossil fuels, they will require 60% more underground storage volume for the larger amount of CO₂ produced.

A desirable application of SOFCs coupled with sequestration is for stationary electrical generation, especially since the most likely fuel, natural gas, is readily utilized in SOFCs. This certainly has major efficiency advantages compared to the pure-H₂-PEMFC approach. In a case where a bio-fuel is utilized with sequestration to achieve net-negative CO₂ emissions, the present pressurized reforming method maximizes efficiency. Compared with conventional electrical generation, there are certainly major efficiency advantages, including the higher SOFC conversion efficiency (60% versus ˜40% for a gas turbine) along with the efficiency cost for separating the CO₂ from the nitrogen-diluted exhaust gas for sequestration. Furthermore, a combustion process will use a purified ethanol fuel, produced using extensive distillation that also incurs an efficiency and cost penalty; this will be much reduced in the present approach that utilizes 3:1 H₂O:EtOH mixture.

Another application is for transportation. CO₂ capture on board vehicles may be used and is expected to be advantageous compared to hydrogen fuel-cells or batteries in the case of heavy-duty long-range vehicles. The storage volume for compressed CO₂ is comparable to the volume of liquid fuels, and the energy for compressing CO₂ is substantially less than that for hydrogen (in any case the CO₂ should ultimately be compressed for sequestration). With on-vehicle CO₂ storage and subsequent transfer (during refueling) for sequestration, such vehicles can be CO₂ neutral or even negative depending on the fuel's origin, comparable to that for pure-H₂-PEMFC vehicles, but with much higher efficiency as discussed above.

### SUMMARY AND CONCLUSIONS

The present method, utilizing pressurized reforming of liquid fuels and yielding a H₂ and CH₄-containing mixture fed to an SOFC, was compared with high-purity hydrogen production by fuel reforming coupled with low-temperature proton-exchange-membrane fuel cells (PEMFCs). The pressurized steam reformer was shown to require substantially less heat than an ambient-pressure reformer, thereby providing a significant efficiency boost. The pressurized reformer is a simple, cost-effective device, such that its use adds little to SOFC system complexity. Pressurization is readily achieved with little energy penalty by injecting the liquid fuel and water into the hot reformer. The methane content can be adjusted to maximize the thermal efficiency benefit and to be suitable for use in the SOFC without risk of coking. If coking were to occur on the reformer catalyst, it could be replaced at low cost and with little down time compared to that of replacing a SOFC stack destroyed by coking. The pressurized reformate also has advantages in cases where the fuel has to be pressurized, e.g., prior to storage or shipping of the reformed fuel, or if the SOFC is to be operated under pressure.

The pressurized process produces reformate with substantial CH₄ content, but when the CH₄ is reformed on the SOFC anode, excess heat produced by the SOFC is available to complete the endothermic reforming process. Thus, the present process can be thought of as shifting the heat requirement from the reformer to the SOFC, which also helps to cool the SOFC. Overall, a fuel-to-electricity efficiency improvement from ˜35% to ˜ 55.5% is achieved, mainly due to the reduced reforming heat requirement, eliminating the need to compress the H₂, and the higher efficiency of SOFCs compared to PEMFCs. The present pressurized reformer method was also compared with SOFCs configured to operate directly by internal reforming; the present method yields the same efficiency benefit while avoiding the risk of damaging the SOFC stack by coking.

The process of oxidizing residual fuel from the SOFC exhaust, in order to obtain a purer CO₂ for sequestration, was also discussed. While there are challenges for oxidizing without introducing substantial N₂, and thereby making sequestration problematic, this was shown to be feasible and also desirable to provide process heat for the SOFC system (e.g., vaporizing the liquid fuel and water reformer input). Indeed, the combination of reduced reformer heat requirements and using SOFC exhaust combustion heat, helps to achieve optimal generation efficiency.

A key application of the present methods is to reduce emissions when fossil fuels are used or to achieve net-negative emissions with bio-fuels such as ethanol. One example is stationary power generation, where a large negative CO₂ emission could be achieved by using a bio-fuel with CO₂ sequestration. Liquid fuels are also ideal for transportation; SOFC-electric vehicles with on-board CO₂ capture are especially desirable for large long-range vehicles that are difficult to electrify using batteries or hydrogen fuel cells.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A method for generating electricity, the method comprising:
injecting a liquid fuel composition comprising a hydrocarbon and water into a reformer, the reformer under a pressure and at an elevated temperature to convert the liquid fuel composition to a reformate composition via a reforming reaction, the reformate composition comprising hydrogen and methane; and
introducing the reformate composition into an anode inlet port of a solid oxide fuel cell in fluid communication with the reformer while introducing oxygen into a cathode inlet port of the solid oxide fuel cell under conditions to convert the reformate composition into an exhaust composition while generating electricity, wherein the solid oxide fuel cell converts the methane of the reformate composition to hydrogen using heat produced during operation of the solid oxide fuel cell.

2. The method of claim 1, wherein the pressure and the elevated temperature are selected to achieve a target enthalpy of the reforming reaction, wherein the target enthalpy of the reforming reaction is less than that of the reforming reaction at ambient pressure and the elevated temperature.

3. The method of claim 2, wherein the target enthalpy of the reforming reaction is no more than 10% of a heat of combustion of the hydrocarbon.

4. The method of claim 2, wherein the target enthalpy of the reforming reaction is no more than 5% of a heat of combustion of the hydrocarbon.

5. The method of claim 1, wherein the pressure is at least 15 bar.

6. The method of claim 1, wherein the pressure is at least 20 bar.

7. The method of claim 5, wherein the elevated temperature is in a range of from 600° C. to 900° C.

8. The method of claim 5, wherein the elevated temperature is in a range of from 600° C. to 775° C.

9. The method of claim 1, the method further comprising adjusting the pressure, the elevated temperature, or both, based on a comparison of a calculated enthalpy of the reforming reaction to a target enthalpy of the reforming reaction.

10. The method of claim 1, wherein the reformate composition is directly introduced from the reformer to the anode inlet port of the solid oxide fuel cell.

11. The method of claim 1, wherein the pressure of the reformer is not the same as a pressure of the solid oxide fuel cell.

12. The method of claim 1, wherein the reformate composition at the pressure and the elevated temperature comprises the methane at a mole fraction of at least 0.10.

13. The method of claim 12, wherein the mole fraction is in a range of from 0.10 to 0.20.

14. The method of claim 1, wherein the reformate composition at the pressure and the elevated temperature comprises the hydrogen at a mole fraction of less than 0.50.

15. The method of claim 1, wherein the reformate composition at the pressure and the elevated temperature comprises the methane at a mole fraction of at least 0.10 and the hydrogen at a mole fraction of less than 0.50.

16. A system for generating electricity, the system comprising:
a reformer comprising
a liquid injector through which a liquid fuel composition comprising a hydrocarbon and water is injected, and
an outlet through which a reformate composition comprising hydrogen and methane is released, the reformer under a pressure and at an elevated temperature to convert the liquid fuel composition to the reformate composition via a reforming reaction; and
a solid oxide fuel cell operatively connected to the reformer and comprising
an anode inlet port through which the reformate composition is received, and
a cathode inlet port through which oxygen is received, the solid oxide fuel condition under conditions sufficient to convert the reformate composition into an exhaust composition while generating electricity, wherein the solid oxide fuel cell is configured to convert the methane of the reformate composition to hydrogen using heat produced during operation of the solid oxide fuel cell.

17. The system of claim 16, further comprising a controller comprising a processor and a non-transitory computer-readable medium operably coupled to the processor, the non-transitory computer-readable medium comprising instructions, that, when executed by the processor, cause the system to receive a target enthalpy of the reforming reaction and to set the pressure and the elevated temperature to values that achieve the target enthalpy of the reforming reaction, wherein the target enthalpy of the reforming reaction is less than that of the reforming reaction at ambient pressure and the elevated temperature.

18. The system of claim 17, wherein the target enthalpy of the reforming reaction is no more than 10% of a heat of combustion of the hydrocarbon.

19. The system of claim 17, the non-transitory computer-readable medium further comprising instructions, that, when executed by the processor, cause the system to adjust the pressure, the elevated temperature, or both, based on a comparison of a calculated enthalpy of the reforming reaction to the target enthalpy of the reforming reaction.

20. The system of claim 16, wherein the reformer and the solid oxide fuel cell are directly connected such that the reformate composition is directly released from the reformer to the anode inlet port of the solid oxide fuel cell.
